(19) United States
(12) Patent Application Publication
(10) Pub. No.: US 2026/0299589 A1
(43) Pub. Date: Oct. 1, 2026

(54) MAPPING SYSTEM FOR MATERIAL DELIVERY SYSTEM INCLUDING AUTONOMOUS MOBILE ROBOT FOR GENERATING AND UPDATING A FACILITY MAP FOR DISTRIBUTION TO LOAD-BEARING AUTONOMOUS MOBILE ROBOTS

(71) Applicant: GM GLOBAL TECHNOLOGY OPERATIONS LLC, Detroit, MI (US)

(72) Inventors: Jesse Heidrich, Shelby Township, MI (US); Joshua Lee Solomon, Berkley, MI (US); Rob John Kempf, Austin, TX (US); Chen Chen, Troy, MI (US); Guanyang Luo, Warren, MI (US)

(21) Appl. No.: 19/094,217

(22) Filed: Mar. 28, 2025

(51) Int. Cl. G05D 1/246; G05D 1/646; G05D 105/80; G05D 107/70; G05D 109/10; G05D 111/10; G05D 111/20; G05D 111/30

(52) U.S. Cl. CPC G05D 1/246; G05D 1/646; G05D 2105/87; G05D 2107/70; G05D 2109/10; G05D 2111/17; G05D 2111/20; G05D 2111/30

(57) ABSTRACT

A mapping system for a facility includes a data center including a transceiver and a server. A mapping autonomous mobile robot (AMR) includes a perception sensor, a motor, a steering actuator, and a transceiver. A controller includes an autonomous driving module configured to navigate the mapping AMR in the facility. A mapping module is configured to receive sensed data from the perception sensor and to generate map data to generate or update a facility map. The transceiver of the mapping AMR is configured to transmit the map data to the transceiver of the data center and M load-bearing AMRs, where M is an integer greater than one. The M load-bearing AMRs include a perception sensor, a motor, a steering actuator, a transceiver configured to receive the facility map from the transceiver of the data center, and a controller including an autonomous driving module configured to navigate using the facility map.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a mapping system, and more particularly to a mapping system for a material delivery system including an autonomous mobile robot for generating and updating a facility map for distribution to other load-bearing autonomous mobile robots.

Autonomous Mobile Robots (AMR) are mobile, load-bearing robots used in material delivery systems to deliver a payload from one location to another without human intervention. The AMRs are required to autonomously navigate complex facilities using onboard sensors (such as depth cameras, lidar sensors, etc.). The AMRs rely on a facility map when navigating in the facility. The facility map needs to be updated on a regular basis to reflect changes and to ensure accuracy. Unfortunately, creating an accurate map of the facility requires a sophisticated and expensive perception sensing system on each of the AMRs. Each facility typically uses multiple AMRs. Adding the perception sensing system to all of the AMRs would increase the cost per unit to an unsustainable level.

### SUMMARY

A mapping system for a facility includes a data center including a transceiver and a server. A mapping autonomous mobile robot (AMR) includes one or more perception sensors, a motor, a steering actuator, and a transceiver. A controller includes an autonomous driving module configured to navigate the mapping AMR in the facility. A mapping module is configured receive sensed data from the one or more perception sensors and to generate map data to at least one of generate and update a facility map. The transceiver of the mapping AMR is configured to transmit the map data to the transceiver of the data center and M load-bearing AMRs, where M is an integer greater than one. The M load-bearing AMRs include one or more perception sensors, a motor, a steering actuator, a transceiver configured to receive the facility map from the transceiver of the data center, and a controller including an autonomous driving module configured to navigate using the facility map.

In other features, the one or more perception sensors of the mapping AMR include at least one of a lidar sensor, an ultrasound sensor, and a camera. The lidar sensor includes a 3D lidar sensor.

In other features, at least one of the one or more perception sensors is scanned and tilted by an actuator. The one or more perception sensors of the mapping AMR have a higher resolution than the one or more perception sensors of the M load-bearing AMRs. The mapping module of the mapping AMR is configured to update an oldest area of the facility map.

In other features the mapping AMR does not carry a payload. The M load-bearing AMRs are configured to use the mapping AMR as a moving fiducial. The mapping module of the mapping AMR is configured to scan for an asset identifier (ID) associated with an asset. The mapping module of the AMR is configured to transmit the asset ID and a corresponding location of the asset ID to the data center.

A method for mapping a facility includes operating a mapping autonomous mobile robot (AMR) in the facility; receiving sensed data from one or more perception sensors of the mapping AMR; generating map data to at least one of generate and update a facility map using the mapping AMR; wirelessly transmitting the map data to a data center; distributing the facility map from the data center to M load-bearing AMRs, where M is an integer greater than one; and navigating the M load-bearing autonomous mobile robots in the facility using one or more perception sensors of the M load-bearing autonomous mobile robots and the facility map.

In other features, the one or more perception sensors of the mapping AMR include at least one of a lidar sensor, an ultrasound sensor, and a camera. The lidar sensor includes a 3D lidar sensor. At least one of the one or more perception sensors is configured for scanning and tilting. At least one of the one or more perception sensors of the mapping AMR has a higher resolution than a corresponding one of the one or more perception sensors of the M load-bearing AMRs.

In other features, the method includes updating an oldest area of the facility map using the mapping AMR. The mapping AMR does not carry a payload. The method includes using the mapping AMR as a moving fiducial for the M load-bearing AMRs. The method includes scanning for an asset identifier (ID) associated with an asset located in the facility using the mapping AMR. The method includes transmitting the asset ID and a corresponding location of the asset ID from the mapping AMR to the data center.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a mapping system for a material delivery system including a mapping autonomous mobile robot (AMR) that generates and updates maps and that transmits the maps to a data center which distributes the facility map to one or more load-bearing AMRs according to the present disclosure;

FIG. 2 is a functional block diagram of an example of a mapping autonomous mobile robot (AMR);

FIG. 3 is a functional block diagram of an example of a load-bearing autonomous mobile robot (AMR);

FIG. 4 is a functional block diagram of an example of a data center according to the present disclosure;

FIG. 5 is a flowchart of an example of a method for operating an automatic mapping system for a facility according to the present disclosure;

FIG. 6 is a flowchart of an example of a method for localization of the load-bearing AMR based on the mapping AMR according to the present disclosure;

FIG. 7 is a flowchart of an example of a method performed by the mapping AMR to select a next location to update according to the present disclosure; and

FIG. 8 is a flowchart of an example of a method for updating asset location using the mapping AMR according to the present disclosure;

In the drawings, reference numbers may be reused to identify similar and/or identical elements.

### DETAILED DESCRIPTION

Autonomous mobile robots (AMRs) are designed to autonomously maneuver payloads throughout complex and changing facilities using onboard perception sensors such as cameras, light detection and ranging sensors, ultrasonic sensors, etc.

Prior to operation, the AMRs require a facility map (such as a simultaneous localization and mapping (SLAM) bitmap or a graphmap). For example, SLAM bitmaps construct and/or update a map of an unknown facility while simultaneously keeping track of the AMR location within the SLAM. SLAM bitmaps create a geometry of an operating facility in which the AMR navigates. The maps are leveraged during AMR navigation to create efficient travel paths and/or to alert the AMR of potential obstacles along a selected path. The AMR creates an instantaneous but unsaved local map while navigating to allow the AMR to avoid unexpected obstacles discovered by onboard sensors.

The shared maps need to be generated and updated on a regular basis. Unfortunately, perception sensors needed to create high-definition facility maps are expensive. As a result, the perception sensors cannot be integrated into the general AMR population due to the numbers of AMRs and the high cost for each AMR. Furthermore, having many AMRs storing or uploading mapping data would increase cost for onboard storage and/or greatly increase burden on the network and data center at the facility.

An automatic mapping system according to the present disclosure includes a sensor-laden autonomous mobile robot (AMR) (e.g., a mapping AMR that is not a load-bearing AMR) that focuses on generating, regenerating, and/or updating a facility map. The mapping data is uploaded to a data center for the facility, processed, and then distributed to the load-bearing AMRs to ensure accurate navigation. The automatic mapping system ensures that the load-bearing AMRs in a facility are operating with an up-to-date facility map, which enables higher performance and more reliable AMR navigation.

The mapping AMR is more maneuverable, smaller, and quicker than the load-bearing AMRs. As a result, the mapping AMR can navigate and map in tight and otherwise inaccessible spaces quickly. Further, the mapping AMR can be used as a point of reference or fiducial for the load-bearing AMRs. In other words, load-bearing AMRs sensing the mapping AMR can use the mapping AMR as a mobile fiducial.

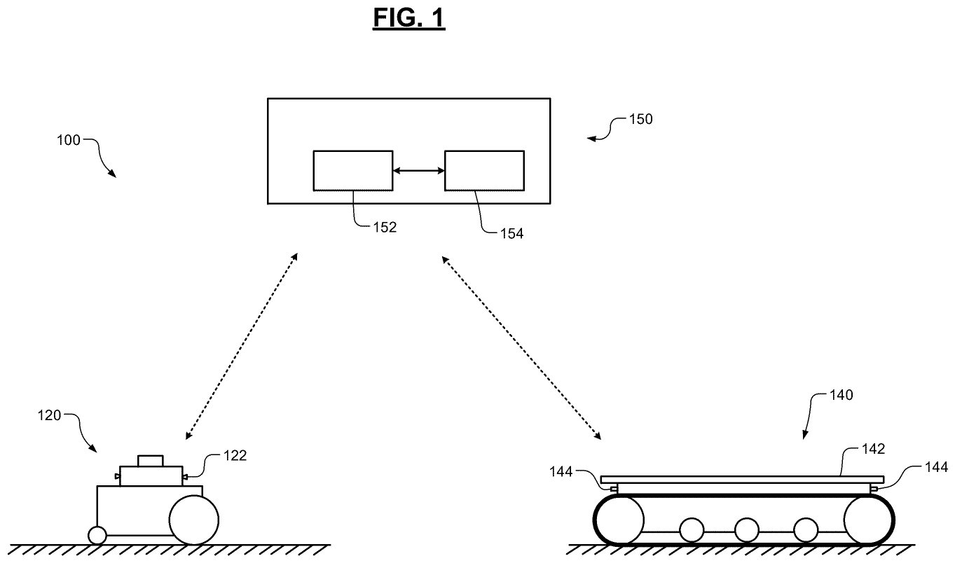

Referring now to FIG. 1, an automatic mapping system 100 includes a mapping autonomous mobile robot (AMR) 120 that generates, regenerates, and updates maps for M load-bearing AMRs 140, where M is an integer greater than one. In some examples, the mapping AMR 120 is generally smaller than the M load-bearing AMRs 140 to allow improved maneuverability. In some examples, the M load-bearing AMRs 140 include a horizontal load platform arranged above a frame and wheels or tracks while the mapping AMR 120 does not. In some examples, the mapping AMR 120 includes a perception system 122 having higher resolution than a perception system 144 of the M load-bearing AMRs 140, which reduces the cost of the M load-bearing AMRs 140.

The mapping AMR 120 wirelessly uploads the mapping data to a data center 150. The data center 150 includes a transceiver 152 and a server 154. The server 154 receives the map data, updates the facility map, and distributes the facility map to M load-bearing AMRs 140. For example, N of the mapping autonomous mobile robots (AMRs) 120 generate a facility map for the M load-bearing AMRs 140, where M and N are integers and M>N. In some examples, M≥2 and N=1. In other examples, M≥2, N≥2, and M>N.

Referring now to FIG. 2, a mapping autonomous mobile robot (AMR) 220 includes a controller 230. The controller 230 includes a mapping module 234 configured to generate, regenerate, and/or update mapping data for a facility. The controller 230 transmits the mapping data to the data center 150 using a wireless and/or wired connection. The mapping AMR 220 scans the facility using one or more perception sensors 239 while navigating the facility and tags data points with a time and location identifier. The mapping AMR 220 and/or the data center 150 combine the map data into a 2D and/or 3D map of the facility.

The controller 230 includes an autonomous driving module 236 configured to monitor outputs of the perception sensors 239 and to navigate in the facility. The controller 230 includes an image/sensor processing module 238 configured to identify objects and their locations within the facility in images generated by cameras and/or sensor data. In some examples, the image/sensor processing module 238 is configured to read identifiers (IDs) attached to assets, identify the location of the asset, and transmits the asset IDs and their locations to the data center.

The mapping AMR 220 includes one or more of the perception sensors 239. For example, the perception sensors 239 may include one or more light detection and ranging (lidar) sensors 240, one or more cameras 242, one or more ultrasound sensors 244, etc. The mapping AMR 220 includes a transceiver 248 that transmits and receives data wirelessly and/or via a wired connection with the data center. The autonomous driving module 236 controls a steering actuator 252 and/or a motor 256 based on outputs of the perception sensors 239 and a facility map using power supplied by a battery system 258.

In some examples, the one or more lidar sensors 240 include a three dimensional (3D) lidar sensor. In some examples, the one or more cameras 242 include a 3D scanning camera. In some examples, one or more of the perception sensors 239 (with a field of view less than 360°) are scanned and/or tilted by one or more actuators 257 to provide a 360° field of view in one or more planes. Using a 3D sensor with scanning or tilting improves the facility maps since 2D sensors miss overhanging structures located above a horizontal scanning plane of the 2D sensors normally used on load-bearing AMRs.

In some examples, the mapping AMR 220 acts as a mobile fiducial to assist with localization of load-bearing AMRs. Current AMRs often employ fixed fiducials on the floor, walls, or other locations of the facility to identify their location. The fiducials are usually fixed in place and their locations are specified in the mapping software when the system is initially set up. As such, when one of the load-bearing AMRs needs localization, the load-bearing AMR detects a nearby fiducial to regain localization.

In complex and changing facilities, the detection of a fiducial for re-localization is not always possible. The primary purpose of the mapping AMR is to create the facility map used for the localization of the load-bearing AMRs in the system. The mapping AMR always knows its position in the facility. The load-bearing AMRs in the facility can sense the mapping AMR, wirelessly communicate with the mapping AMR, exchange location information with the mapping AMR, and pinpoint the location of the load-bearing AMR in the facility map.

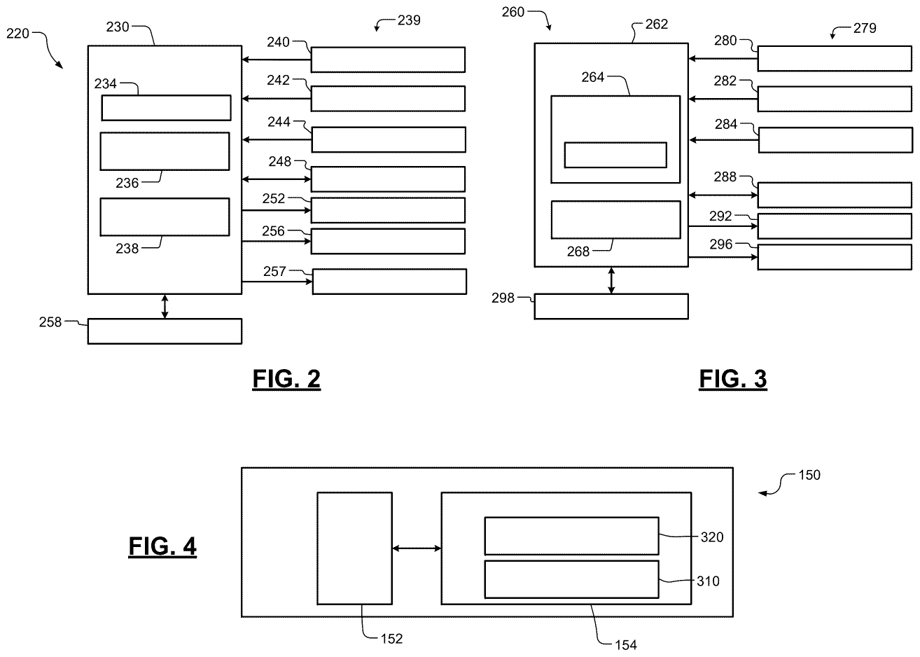

Referring now to FIG. 3, a load-bearing autonomous mobile robot (AMR) 260 includes a controller 262 including an autonomous driving module 264 configured to store a facility map received from the data center using either a wireless or wired connection. The autonomous driving module 264 is configured to monitor perception sensors and to navigate within the facility using the facility map. The controller 262 includes an image/sensor processing module 268 configured to receive sensed signals from perception sensors 279 and to perform image processing and/or analysis.

The load-bearing AMR 260 includes one or more perception sensors 279. For example, the one or more perception sensors 279 may include one or more light detection and ranging (lidar) sensors 280, one or more cameras 282, one or more ultrasound sensors 284, etc. The load-bearing AMR 260 includes a transceiver 288 that communicates wirelessly and/or via a wired connection with the data center. The autonomous driving module 264 controls a steering actuator 292 and/or a motor 296 based on the facility map and the one or more perception sensors 279 using power supplied by a battery system 298.

In some examples, the one or more lidar sensors 280 have lower resolution than the one or more lidar sensors 240 of the mapping AMR 220. In some examples, the one or more lidar sensors 280 include a two dimensional (2D) lidar sensor that senses a horizontal plane. In some examples, the one or more cameras 282 have a lower resolution than the one or more cameras 242. In some examples, the perception sensors are limited to forward and reverse views without scanning or tilting. In some examples, the one or more perception sensors 259 are arranged at a predetermined height above the ground (e.g., less than 1 foot or 2 feet) and are limited to 2D forward and rear views.

Referring now to FIG. 4, the server 156 of the data center 150 includes a map updating module 310 and a map distributing module 312. The map updating module 310 receives map data from the mapping AMR 220, updates the facility map based thereon, and then distributes the updated facility map to the load-bearing AMRs 260. In some examples, the map updating module 310 sends a message to the mapping AMR 220 requesting an updated map for a predetermined area of the facility and the receives the updated mapping data in response thereto. In other examples, the mapping AMR 220 identifies an oldest area of the facility map, generates updated mapping data for the oldest area, and uploads updated mapping data to the data center 150 in response thereto (and then repeats with the next oldest map area).

By referencing the timing and location tags on previously acquired data, the data center 150 and/or the mapping AMR 220 can determine when data is old and/or whether a new area of a facility needs to be mapped. For example, if a specific area of the facility has data that is time stamped with a date older than other regions, the data center and/or the mapping AMR can autonomously maneuver to the area of the facility to remap and create up-to-date map information.

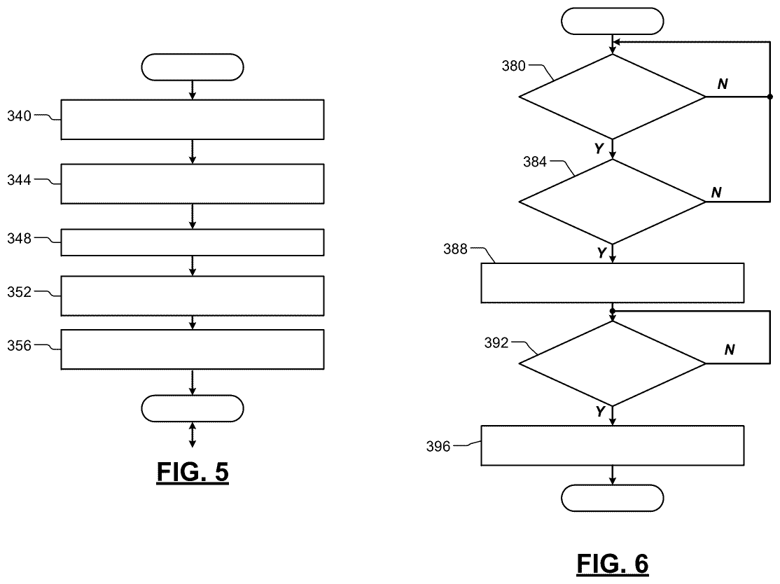

Referring now to FIG. 5, a method for operating an automatic mapping system is shown. At 340, the mapping ARM moves through facility and maps the facility. At 344, the mapping ARM transmits mapping data to the data center. At 348, the data center stores and updates the maps. At 352, the data center distributes the maps to the load-bearing AMRs. At 356, the load-bearing AMRs navigate the facility using the maps.

Referring now to FIG. 6, a method for localizing a load-bearing AMR using the known location of the mapping AMR is shown. At 380, the method determines whether the load-bearing AMR needs localization. If 380 is true, the method determines whether the load-bearing AMR senses the mapping AMR at 384. If 384 is true, the load-bearing AMR sends a localization request to the mapping AMR at 388. At 392, the load-bearing AMR determines whether a response is received. If 392 is true, the load-bearing AMR updates its localization based on the response at 396.

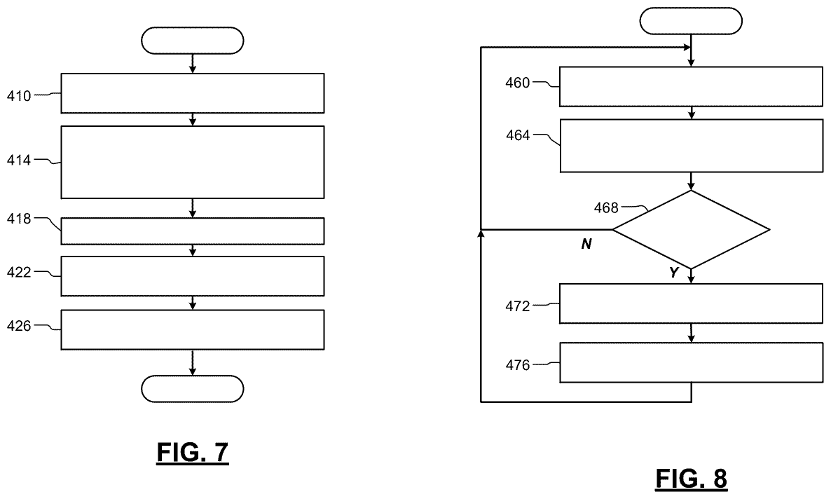

Referring now to FIG. 7, a method for updating the facility map is shown. At 410, the mapping ARM identifies the area of the facility with the oldest mapping. At 414, the mapping ARM travels to and updates the oldest mapped area and transmits the updated mapping data to the data center. At 418, the data center stores and updates the corresponding area of the facility map. At 422, the data center downloads the updated facility map to the load-bearing AMRs. At 426, the load-bearing AMRs navigate using the updated facility map.

Referring now to FIG. 8, a method for autonomous object/asset tracking is shown. The mapping ARM moves through the facility and maps the facility at 460. At 464, the mapping ARM scans for asset identification (ID) tags such as quick response (QR) codes, bar codes, part numbers, bin numbers, etc. At 468, the mapping ARM determines whether one of the asset ID tags is detected. When 468 is true, the mapping ARM transmits the asset ID and its location to the data center at 472. The data center stores and updates the asset location relative to the facility map at 476.

The mapping ARM leverages onboard perception and localization capabilities to identify assets and their locations during mapping. Once the asset ID is detected, the asset can be catalogued in the facility map since the location is known. The mapping AMR enables autonomous mapping of the location of assets in the facility without human input.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A mapping system for a facility, comprising:
a data center including a transceiver and a server;
a mapping autonomous mobile robot (AMR) including:
one or more perception sensors;
a motor;
a steering actuator;
a transceiver;
a controller including:
an autonomous driving module configured to navigate the mapping AMR in the facility;
a mapping module configured receive sensed data from the one or more perception sensors and to generate map data to at least one of generate and update a facility map,
wherein the transceiver of the mapping AMR is configured to transmit the map data to the transceiver of the data center; and
M load-bearing AMRs, where M is an integer greater than one, including:
one or more perception sensors;
a motor;
a steering actuator;
a transceiver configured to receive the facility map from the transceiver of the data center; and
a controller including an autonomous driving module configured to navigate using the facility map.

2. The mapping system of claim 1, wherein the one or more perception sensors of the mapping AMR include at least one of a lidar sensor, an ultrasound sensor, and a camera.

3. The mapping system of claim 2, wherein the lidar sensor includes a 3D lidar sensor.

4. The mapping system of claim 1, wherein at least one of the one or more perception sensors is scanned and tilted by an actuator.

5. The mapping system of claim 1, wherein the one or more perception sensors of the mapping AMR have a higher resolution than the one or more perception sensors of the M load-bearing AMRs.

6. The mapping system of claim 1, wherein the mapping module of the mapping AMR is configured to update an oldest area of the facility map.

7. The mapping system of claim 1, wherein the mapping AMR does not carry a payload.

8. The mapping system of claim 1, wherein the M load-bearing AMRs are configured to use the mapping AMR as a moving fiducial.

9. The mapping system of claim 1, wherein the mapping module of the mapping AMR is configured to scan for an asset identifier (ID) associated with an asset.

10. The mapping system of claim 9, wherein the mapping module of the AMR is configured to transmit the asset ID and a corresponding location of the asset ID to the data center.

11. A method for mapping a facility, comprising:
operating a mapping autonomous mobile robot (AMR) in the facility;
receiving sensed data from one or more perception sensors of the mapping AMR;
generating map data to at least one of generate and update a facility map using the mapping AMR;
wirelessly transmitting the map data to a data center;
distributing the facility map from the data center to M load-bearing AMRs, where M is an integer greater than one; and
navigating the M load-bearing autonomous mobile robots in the facility using one or more perception sensors of the M load-bearing autonomous mobile robots and the facility map.

12. The method of claim 11, wherein the one or more perception sensors of the mapping AMR include at least one of a lidar sensor, an ultrasound sensor, and a camera.

13. The method of claim 12, wherein the lidar sensor includes a 3D lidar sensor.

14. The method of claim 11, wherein at least one of the one or more perception sensors is configured for scanning and tilting.

15. The method of claim 11, wherein at least one of the one or more perception sensors of the mapping AMR has a higher resolution than a corresponding one of the one or more perception sensors of the M load-bearing AMRs.

16. The method of claim 11, further comprising updating an oldest area of the facility map using the mapping AMR.

17. The method of claim 11, wherein the mapping AMR does not carry a payload.

18. The method of claim 11, further comprising using the mapping AMR as a moving fiducial for the M load-bearing AMRs.

19. The method of claim 11, further comprising scanning for an asset identifier (ID) associated with an asset located in the facility using the mapping AMR.

20. The method of claim 19, further comprising transmitting the asset ID and a corresponding location of the asset ID from the mapping AMR to the data center.
